(19) United States
(12) Patent Application Publication
(10) Pub. No.: US 2013/0065026 A1
(43) Pub. Date: Mar. 14, 2013

(54) METHOD FOR PREPARING COMPOSITE MATERIALS

(71) Applicants: Andreas Walther, Koln (DE); Antti Laukkanen, Helsinki (FI); Olli Ikkala, Helsinki (FI)

(72) Inventors: Andreas Walther, Koln (DE); Antti Laukkanen, Helsinki (FI); Olli Ikkala, Helsinki (FI)

(73) Assignee: UPM-KYMMENE CORPORATION, Helsinki (FI)

(21) Appl. No.: 13/582,821

(22) PCT Filed: Mar. 3, 2011
(86) PCT No.: PCT/FI2011/050186

§ 371 Date: Nov. 20, 2012

(30) Foreign Application Priority Data
Mar. 5, 2010 (FI) 20105224

(51) Int. Cl. B32B 37/12; B32B 27/04

(52) U.S. Cl. CPC B32B 37/1284; B32B 27/04; B82Y 30/00
USPC 428/195.1; 156/60; 156/327; 977/742

(57) ABSTRACT

A method for preparing composite structure self-assemblies. Structural segments are formed, which connect to each other through binder material. The structural segments are combined with the binder material to produce structural segments having the binder adhered thereto. The structural segments are combined to a form a composite structure through self-assembly, where the structural segments join to each other through said binder.

### FIELD OF INVENTION

This invention relates to a method for preparing composite material. This invention also relates to mechanically strong composite materials comprising hard reinforcing components and soft toughening components. The invention relates particularly to processes to prepare materials and shaped articles, such as structural parts, films, laminates, parts, containers, thermal barriers, gas barriers, tapes, coatings, electrical conductors, and the like, and the use of the same compositions.

### BACKGROUND OF INVENTION

In engineering applications there is a common need for materials that have good mechanical properties and low weight, in other words low density. Numerous applications require high stiffness, high strength and high toughness. Depending on the specific applications, deformation modes are defined differently, but typical common parameters are the tensile modulus, tensile strength and fracture toughness. If one scales such parameters by the materials density, specific modulus, specific strength and specific toughness are obtained, which describe the mechanical efficiency, i.e. how much material is required to sustain certain mechanical stresses or obtain given material properties. Such reasonings are familiar to those skilled in the art, and are described in detail e.g. in Michael F. Ashby, Materials Selection in Mechanical Design, Elsevier, 2005.

Obtaining high specific mechanical efficiency is of widespread importance in many applications, in particular also considering low energy and low cost production strategies. A replacement of highly-energy intensive ceramics and metals with soft matter, natural or renewable materials and their combinations is highly desirable. Considering lightweight materials as such, the most natural applications are where mechanically-robust items, devices, equipments and constructs are being moved. There lightweight constructs, still having feasible mechanical properties provide energy savings, such as in vehicles, cars, tractors, trucks, vans, airplanes, helicopters, space crafts, cranes, ships, bikes, motorcycles, and the like. But also, for example, in portable electronics, mobile phones, laptops, navigation devices, earphones, portable devices for music, pictures and films, as well as in e.g. in portable communication, sensors, analysis devices, biodevices, medical devices, and transplants such properties are useful. Moreover, indirect considerable savings can be obtained by lightweight constructions during the actual construction phase even if the actual constructs are not mobile, as the transportation costs are minimized.

Therefore, one can conclude that it is a universal goal to minimize the needed weight or volume of materials for certain required mechanical properties.

Metals have been extensively used in applications requiring good mechanical properties, and towards improved mechanical efficiency lightweight alloys are used, for example in airplanes, and vehicles. Still, there is a tremendous need towards improved mechanical efficiency where societal needs for energy savings and sustainable technologies pose additional requirements. Polymeric composite materials have extensively been pursued by adding various reinforcements, such as glass fiber, carbon fiber, wood-fibers, hamp, wovens, non-wovens, textiles, polymer fibers, or even metal fibers, see for example, Nanocomposite Science and Technology; Ajayan, P. M.; Schadler, L. S.; Braun, P. V., Eds.; VCH-Wiley: Weinheim, 2004. Light-weight structures with applicable mechanical properties are achieved, as relevant for many applications. Carbon-fiber reinforced composites can serve as good examples. Therein, high specific strength, stiffness and toughness values can be obtained in a very lightweight construction material. Yet it is commonly known that they are mostly limited to small scale productions of very expensive constructs, such as racing cars, jets or applications in the defense sector. This owes to the laborious and time-consuming sequential impregnation of layers of the carbon fibers with the resins. Hence, the promise of everyday-life carbon-fiber reinforced composites has not been fulfilled yet.

Consequently, equally important than the mechanical efficiency towards major applications is to achieve facile and commodity processing. In metals and in conventional thermoplastic polymers, the processing is achieved by different melting processes where the material is transformed in a flowing state by heating. To allow these processing strategies, there has been a search to use thinner reinforcement fibers such as carbon nanotubes, cellulose nanofibers, plate-like nanofillers as nanoclay or layered silicates, such as montmorillonite, laponite, hectorite or alike, or graphene as reinforcements, see for example Macromolecular Engineering; Matyjaszewski, K.; Gnanou, Y.; Leibler, L., Eds.; Wiley-VCH: Weinheim, 2007. The compositions and processing conditions vary widely, but the processing constraints in combination with the typically higher price of the reinforcement materials have directed the composition in polymer nanocomposites towards low weight fraction of the reinforcement within the polymer matrix, typically a few percent or less. The prior art discloses a wide selections of examples, where a typical reinforcement is montmorillinite, see L. A. Utracki, Clay-Containing Polymer Nanocomposites, Rapra Technology Ltd., 2004; M. Okamoto: Chapter 3: Polymer/layered Filler Nanocomposites: An overview from Science to Technology, in Macromolecular Engineering Volume 4; Matyjaszewski, K.; Gnanou, Y.; Leibler, L., Eds.; Wiley-VCH: Weinheim, 2007 and M. Alexander and P Bubois: Chapter 2: Nanocomposites, in Macromolecular Engineering Volume 4; Matyjaszewski, K.; Gnanou, Y.; Leibler, L., Eds.; Wiley-VCH: Weinheim, 2007. To illustrate the state-of-the art with a one generic example, addition of 5% of exfoliated montmorillonite to an example polymer matrix (polyethylene) increases the modulus from 0.5 GPa to 0.7 GPa, increases the strength from 18 MPa to 20 MPa, but reduces the maximum strain from 140% to 110%. This shows that the some of the mechanical properties of the host polymer are improved. This approach has warranted extensive applications, e.g. in automotive industry, as disclosed by patent specifications by Toyota (JP 57090050 A, DE 3632865 A1, DE 3806548 A1). At low weight fractions of reinforcements, at best percolation of the reinforcements can be achieved which leads to a satisfying improvement when comparing on the commodity polymer property scale. However, vastly improved properties and especially attempting a competition with metals, ceramics or high performance biological materials has remained a widely unsolved challenge.

Therefore, there is need to identify new routes for lightweight materials with drastically improved mechanical properties.

Nature provides examples of composites which have enormously good mechanical properties. A typical example is given by the nacreous shell of mollusk that has a tensile modulus of ca. 70 GPa and the tensile strength of ca. 150 GPa, see Meyers, M. A.; Chen, P.-Y.; Lin, A. Y.-M.; Seki, Y. Prog. Mater. Science 2008, 53, 1-206. This is achieved by a composite where aragonite (CaCO₃) platelets of thicknesses of ca 350-500 nm are glued together by a very thin protein layer of 20-40 nm. In other words, unlike the commodity nanocomposites, nacre possesses reinforcement material as the majority phase and the polymer constitutes the minority phase. This principle is common among many high-performance biological composite materials. This composition poses, however, major problems to commodity thermoplastic polymer processing techniques, as the materials do not flow due to the high weight fraction of the solid fillers. Another example is silk, which has slightly lower modulus of 10 GPa, but the strength can be even 1 GPa, see Meyers, M. A.; Chen, P.-Y.; Lin, A. Y.-M.; Seki, Y. Prog. Mater. Science 2008, 53, 1-206. These values have to be compared with those of steel, considering its high density: High strength steel (ASTM A514) has a modulus of 210 GPa and strength 760 MPa, and mild steel a modulus of 210 GPa and stiffness of 350 MPa (density 7.8 g/cm³). On the contrary, silk is a fully organic nanocomposite with a low density and a material with reinforcing beta-sheet domains having weight fraction of ca. 50%—again high. The natural processing of silk takes place in a fluid state, where the reinforcements are converted in-situ. Via this way, animals are able to create high-performance fibers.

In summary, biological nanocomposite materials can have mechanical properties approaching those of steel, still exhibiting only a fourth or less of its density. Therefore, biological materials exhibit very attractive high values of mechanical efficiency. This suggests using biological materials in engineering. However, biological materials are expensive and slow to produce, which encourages focusing on a mimicry of the essential properties of biological materials.

For example, nacre can be mimicked by sequential deposition of nanoclay and polymer layers by so called layer-by-layer deposition or sequential spin coatings of reinforcement inorganic layers and polymer layers, described in references: Tang, Z.; Kotov, N. A.; Magonov, S.; Ozturk, B. Nature Materials 2003, 2, 413-418; Podsiadlo, P.; Kaushik, A. K.; Arruda, E. M.; Waas, A. M.; Shim, B. S.; Xu, J.; Nandivada, H.; Pumplin, B. G.; Lahann, J.; Ramamoorthy, A.; Kotov, N. A. Science 2007, 318, 80-83; Bonderer, L. J.; Studart, A. R.; Gauckler, L. J. Science 2008, 319, 1069-1073.

Patent publications that demonstrate the formation of layered composite materials employing high-aspect ratio colloids and polymers to mimic nacre include WO2009085362 A2, US 20040053037, US20010046564, and US 7438953. These patents are also restricted to thin films and sequential deposition techniques. They fail to show materials of possibly unlimited thickness due to their multistep processes on finite specimens.

U.S. Pat. No. 6,387,453 and U.S. Pat. No. 6,264,741 describe self-assembly processes at interfaces yielding layered composite materials. Similar as mentioned above, these methods fail to address unlimited thicknesses, thick films and laminates. Furthermore, they utilize silica sols and their precursors as well as in-situ reaction schemes. Thus it is conceptionally a very different approach.

Use of nanoclay (montmorillonite) in packaging laminate coatings is disclosed by EP patent 1263654. This technology uses a coating composition where nanoclay particles are dispersed in a barrier polymer resin and the proportion of resin to clay is large.

Even if feasible nacre-mimetic mechanical properties are obtained in the small laboratory scale in thin films, the preparation of thick coatings or bulk materials is prohibitively slow: even preparation of tens of m layer can take a week due to the sequential nature of the process. On the other hand, ceramic processing techniques have been used, but they are very energy intensive as they both require cryogenic freezing and high temperature sintering, see Munch, E.; Launey, M. E.; Alsem, D. H.; Saiz, E.; Tomsia, A. P.; Ritchie, R. O, Science 322, 1516 (2008); Deville, S.; Saiz, E.; Nalla, R. K.; Tomsia, A. P. Science 311, 515 (2006). Similarly, high-performance materials with a high content of rod-like or fibre-like reinforcements, that are essentially similar to silk or wood, face similar obstacles. They mostly require the laborious infiltration of deposited carbon nanotubes, cellulose whiskers or nanofibrillated cellulose with resins and subsequent polymerizations, for example Capadona, J. R.; van den Berg, O.; Capadona, L. A.; Schroeter, M.; Rowan, S. J.; Tyler, D. J.; Weder, C. Nat. Nanotech. 2007, 2, 765-768; Nakagaito, A. N.; Yano, H. Appl. Phys. A 2005, 80, 155-159; Nogi, M.; Yano, H. Adv. Mat. 2008, 20, 1849-1852; Nogi, M.; Iwamoto, S.; Nakagaito, A. N.; Yano, H. Adv. Mat. 2009, 20, 1-4, and in patent disclosures US 2008242765 A1, US 2009318590 A1, JP 2008297364 A, JP 2008266630 A, JP 2008248093 A, WO 2008117848 A1, WO 2008010449 A1, and WO 2006082964 A1.

As is evident from the above analysis, there are still major obstacles existing in the preparation of high-performance lightweight soft-matter based composite materials with a high content of reinforcing agent, as inspired by nacre and silk. Both the limited methodologies for their productions as well as the associated costs prevent a large-scale manufacturing. Therefore, there is a need to prepare “nacre-like” or silk-like materials with production-friendly techniques.

### SUMMARY OF THE INVENTION

It is an object of the present invention to provide a method for preparing structural assemblies of “hard” segments of reinforcing particles and binder material at a faster rate as before. An object of the invention is also to provide assemblies of said hard segments and binding material, whether as free film, coating on any substrate, or in other shape that can be made dimensionally larger as before within a reasonable time and used in various applications.

The method involves two steps: in a first step, the structural segments, “reinforcements” providing the strength of the composition, are provided with binder, usually a polymer, which can be adhered to the particles in a suitable way; in a second step, these structural segments provided with the binder are self-assembled to a solid assembly from a medium, usually from a liquid where these segments are dispersed.

The structural segments, which in the three orthogonal directions (xyz) have one or two dimensions larger than the two or one remaining ones, respectively, act as sort of building blocks that provide the strength to the composite, that is, reinforce the composite. The binder acts as a sort of glue between these building blocks. By oversimplification it can be said that the final composite resembles a sort of nanoscale brickwork (brick and mortar structure) where the structural segments correspond to bricks and the binder corresponds to mortar. In this composite, the structural segments are oriented along their longest dimensions, and the final composite is characterized by a distinctly oriented nanostructure.

More specifically the invention relates to a method where plate-like or fiber-like reinforcements are first covered by a soft coating comprising a binder, such as polymer, within a liquid medium to form a core-shell plates or core-shell fibers, and thereafter the said core-shell plates or fibers are let to pack by removing the said solvent medium to form solid composite material. Most specifically the invention relates processes, where the core-shell plates and fibers undergo processing and liquid removal by paper-making, painting, doctor-blading, or spraying or the like.

It will be demonstrated in the following description of the invention, and more specifically in the Examples attached hereto, that a particular method surprisingly exists to render mechanically excellent lightweight materials, allowing commodity processings like painting, doctor-blading by spreading slurries, paper-making by filtration on substrates, or sprayings for technological products. The method comprises of two steps:
i) coating of selected plate-like and fibrillar-like hard reinforcing components in a liquid medium by a soft binder layer, comprising at least one polymer, to form core-shell platelets or fibers
ii) processing a slurry or dispersion comprising of at least one type core-shell platelets or core-shell fibers to remove the liquid medium and to provide alignment of the platelets or fibers by papermaking, painting, doctor-blading, or spraying or the like, optionally followed by chemical or physical crosslinking of the polymers within the shells.

The first step and the second step can be performed in the same medium (liquid phase), that is, providing the reinforcing components with the binder can be followed by processsing of the same medium so that the reinforcing components provided with the binder are assembled to the composite. However, it is also possible that the first step and the second step take place in physically separate mediums. In this case the liquid used in both steps as the medium may be chemically the same, like water, but washing or other steps may be involved between the first step and the second step.

The expected compositions and processes may vary widely and the following examples are presented merely to illustrate the invention and are not be construed as limitations thereof.

### DESCRIPTION OF THE FIGURES

The invention will be described in the following with reference to the appended drawings where:

FIGS. 1a and 1b are scanning force microscopy images for montmorillonite (MTM) on freshly cleaved mica to demonstrate polymer coating of plate-like reinforcing particle, and they show height (Fig. a, h=4.4 nm) and phase (Fig. b, 0°-40°) images of polyvinyl alcohol (PVA)-coated MTM on freshly cleaved mica. The cross sections along the lines in Fig. a are shown in Fig. c. The coating is evident in the phase image and leads to an increase of the thickness as compared to pure clay platelets (not shown).

FIGS. 2a and 2a are scanning electron microscopy images of various layered composites. FIG. 2a shows a layered composite created via paper-making/filtration of poly(diallyl dimethyl ammonium chloride)/MTM building blocks. Different amounts lead to different thicknesses as shown on the left-hand side. The high resolution images on the right provide evidence for a layered arrangement of the building blocks parallel to the filtration mat. FIG. 2b is a series of SEM images of polyisoprene-block-poly(2-vinylpyridinium iodide)/anionic microfibrillated cellulose composite (PI-P2VPq micelles/anionic MFC), also demonstrating a layered structure.

FIGS. 3a and 3b are SEM images of layered composite materials of PVA/MTM obtained via painting (a) and doctor-blading (b) of viscous slurries onto substrates. FIG. 3b shows the optical translucency of a 0.02 mm thick doctor-bladed film.

### DETAILED DESCRIPTION OF THE INVENTION

According to a specific embodiment, the present invention comprises two steps
i) selection of hard platelike reinforcement components (to be denoted as Component A) or hard fiberlike reinforcement components (to be denoted as Component B) which are coated in a liquid medium with soft layer comprising of one or more polymers (to be denoted as Component C) to produce core-shell platelets or core-shell fibers;
ii) processing a dispersion or slurry in the same or subsequent liquid medium comprising at least one type of said core-shell platelets or core-shell fibers to remove the liquid medium and to provide alignment of the core-shell platelets or core-shell fibers by papermaking, painting, doctor-blading, or spraying or the like, optionally followed by chemical or physical crosslinking of the polymers within the shells.

### Components A

Platelet-shaped reinforcing particles intended for the conjugation with components C can be selected from a wide variety of materials that allow specific interactions. Such particles include, but are not limited to, clay minerals, talc, gibbsite, graphene, graphite flakes, hexagonal boronitride, boronitride nanosheets, mica platelets, glass flakes, aluminium oxide platelets, titanium dioxide platelets, as well as silver, gold or platinum platelets. Surface-modifications to tailor the interactions are specifically included.

The size of these colloidal particles may vary widely. Generally colloids with one dimension smaller than 500 nm are preferred. Their smallest dimension (thickness) can be down to ca. 1 nm as in MTM, whereas in some embodiments submicrometer thickness is preferred. Graphenes lead to very thin platelets. As to shape, the platelets can be described as “2-dimensional” which means that they have considerably larger dimensions in two orthogonal directions than in the third one. Consequently, they have typically a sufficiently high aspect ratio, at least 2.5, preferably ca. 5 or higher.

### Components B

Rod-like reinforcing particles intended for conjugation to components C include, but are not limited to, nano/microfibrillar cellulose, cellulose nanocrystals or nanowhiskers, SiC whiskers, or carbon nanotubes. Surface-modifications to tailor the interactions are specifically included.

The size of these fibers may vary widely. Their smallest dimension (thickness) can be ca. 4-20 nm as in MFC whereas in some embodiments submicrometer thickness is preferred. As to shape, they can be described as “1-dimensional” which means that they have considerably smaller dimensions in two orthogonal directions than in the third one. Consequently, they also have typically a high aspect ratio

### Components C

Energy-dissipating soft materials for the chemisorption or physisorption onto the reinforcing components A and B comprise at least one binding motif, and the material is therefore called a “binder”. These binding motifs may contain, but are not limited to, ionic groups, alcohols, thiols, amines, phosphinoxides or moieties for hydrogen-bonding or aromatic interactions, or any functional groups capable of covalent bonding with the A and/or B component. The materials are typically composed of polymers, their self-assemblies or nanoscale and microscale dispersions. The structures of polymers include, but are not limited to, homopolymers or copolymers with linear, star-shaped, branched or grafted architectures, as well as polypeptides, polysaccharides, and nucleic acids. Their self-assembled structures, such as micelles or vesicles can also be used. Similarly, nanoscale and microscale particles, such as natural or synthetic latexes or polymeric nanoparticles can be applied. Thus there is wide selection of components C to be selected, to be selected according to general selection criteria that are clear for those skilled in the art.

### Nanofibrillar Cellulose as Specific Example of Component B

One preferable material for component B is nanofibrillar cellulose (NFC). In aqueous environment the nanofibrillar cellulose (also known as microfibrillar cellulose, MFC) consists of cellulose fibres whose diameter is in the submicron range.

The nanofibrillar cellulose is prepared normally from cellulose raw material of plant origin. The raw material can be based on any plant material that contains cellulose. The raw material can also be derived from certain bacterial fermentation processes. Plant material may be wood. Wood can be from softwood tree such as spruce, pine, fir, larch, douglas-fir or hemlock, or from hardwood tree such as birch, aspen, poplar, alder, eucalyptus or acacia, or from a mixture of softwoods and hardwoods. Non-wood material can be from agricultural residues, grasses or other plant substances such as straw, leaves, bark, seeds, hulls, flowers, vegetables or fruits from cotton, corn, wheat, oat, rye, barley, rice, flax, hemp, manila hemp, sisal hemp, jute, ramie, kenaf, bagasse, bamboo or reed. The cellulose raw material could be also derived from the cellulose-producing micro-organism. The micro-organisms can be of the genus Acetobacter, Agrobacterium, Rhizobium, Pseudomonas or Alcaligenes, preferably of the genus Acetobacter and more preferably of the species Acetobacter xylinum or Acetobacter pasteurianus.

The term “nanofibrillar cellulose” refers to a collection of isolated cellulose microfibrils or microfibril bundles derived from cellulose raw material. Microfibrils have typically high aspect ratio: the length might exceed one micrometer while the number-average diameter is typically below 200 nm. The diameter of microfibril bundles can also be larger but generally less than 1 μm. The smallest microfibrils are similar to so called elementary fibrils, which are typically 2-12 nm in diameter. The dimensions of the fibrils or fibril bundles are dependent on raw material and disintegration method. The nanofibrillar cellulose may also contain some hemicelluloses; the amount is dependent on the plant source. Mechanical disintegration of microfibrillar cellulose from cellulose raw material, cellulose pulp, or refined pulp is carried out with suitable equipment such as a refiner, grinder, homogenizer, colloider, friction grinder, ultrasound sonicator, fluidizer such as microfluidizer, macrofluidizer or fluidizer-type homogenizer. In this case the nanofibrillar cellulose is obtained through disintegration of plant celluose material and can be called “nanofibrillated cellulose”. “Nanofibrillar cellulose” can also be directly isolated from certain fermentation processes. The cellulose-producing micro-organism of the present invention may be of the genus Acetobacter, Agrobacterium, Rhizobium, Pseudomonas or Alcaligenes, preferably of the genus Acetobacter and more preferably of the species Acetobacter xylinum or Acetobacter pasteurianus. “Nanofibrillar cellulose” can also be any chemically or physically modified derivate of cellulose nanofibrils or nanofibril bundles. The chemical modification could be based for example on carboxymethylation, oxidation, esterification, or etherification reaction of cellulose molecules. Modification could also be realized by physical adsorption of anionic, cationic, or non-ionic substances or any combination of these on cellulose surface. The described modification can be carried out before, after, or during the production of microfibrillar cellulose.

The nanofibrillated cellulose can be non-parenchymal cellulose. The non-parenchymal nanofibrillated cellulose may be in this case cellulose produced directly by micro-organisms in a fermentation process or cellulose originating in non-parenchymal plant tissue, such as tissue composed of cells with thick, secondary cell wall. Fibres are one example of such tissue.

The nanofibrillated cellulose can be made of cellulose which is chemically premodified to make it more labile. The starting material of this kind of nanofibrillated cellulose is labile cellulose pulp or cellulose raw material, which results from certain modifications of cellulose raw material or cellulose pulp. For example N-oxyl mediated oxidation (e.g. 2,2,6,6-tetramethyl-1-piperidine N-oxide) leads to very labile cellulose material, which is easy to disintegrate to microfibrillar cellulose. For example patent applications WO 09/084,566 and JP 20070340371 disclose such modifications. The nanofibrillated cellulose manufactured through this kind of premodification or “labilization” can be called labilized nanocellulose, in contrast to nanofibrillated cellulose which is made of not labilized or “normal” cellulose.

### Proportion of Components Used

In the combination of Component A or B with component C, the proportion of component C (binder) is smaller than component A or B (reinforcing particle). In the final composite this will be also seen as larger amount of reinforcing particles compared with the binder, that is, the reinforcement constitutes over 50 wt-%, preferably over 70 wt-% of the total weight of the composite.

### Method A

A layer comprising at least one of the components C (binder) is coated onto platelet-shaped, 2-dimensional reinforcement blocks mentioned as component A. This coating preferentially takes place in water and is mediated by physisorption or chemisorption of the components C (binder) onto the platelets of A. Afterwards, the excess of the coating agent, C, is removed. Methods of removal are for instance, but not limited to, centrifugation and redispersion or sedimentation and decantation. This process yields coated platelet-shaped building blocks used in further self-assembly processes with a minimum of energy-dissipating binder.

### Method B

A layer comprising at least one of the components C (binder) is coated onto fiber-like, 1-dimensional reinforcement blocks mentioned as component B. This coating preferentially takes place in water and is mediated by physisorption or chemisorption of the components C onto the fibers or rod-like particles described as component B. Afterwards, the excess of the coating agent, component C, can be removed. Methods of removal are for instance, but not limited to, centrifugation and redispersion or sedimentation and decantation. This process yields coated rod-shaped building blocks used in further self-assembly processes with a minimum of energy-dissipating binder.

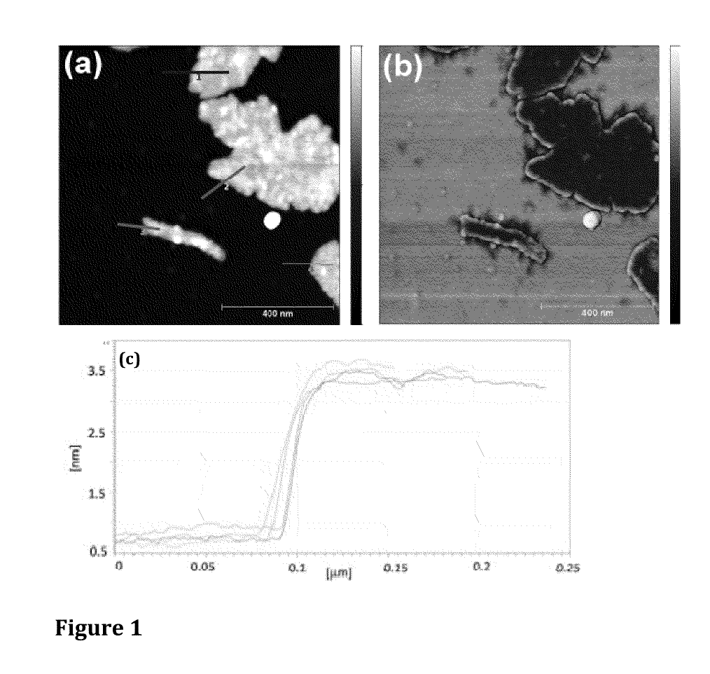

For both Methods, A and B, a successful coating can be shown via microscopy, e.g. scanning force microscopy (SFM) or electron microscopy in scanning (SEM) and transmission (TEM) mode. For fluorescently labeled components A, fluorescence microscopy is also suitable. As an example, FIGS. 1a and 1b provide scanning force microscopy images of poly(vinyl alcohol) (PVA) coating on montmorillonite (MTM) clay nano-platelets.

### Method C

Forced and accelerated self-assembly of the hard/soft building blocks as generated with methods A and B can be induced via paper-making/filtration. Depending on the aimed thickness, a desired quantity of a given concentration is loaded onto the filtration mat and vacuum filtered. Afterwards, the specimens are removed and dried.

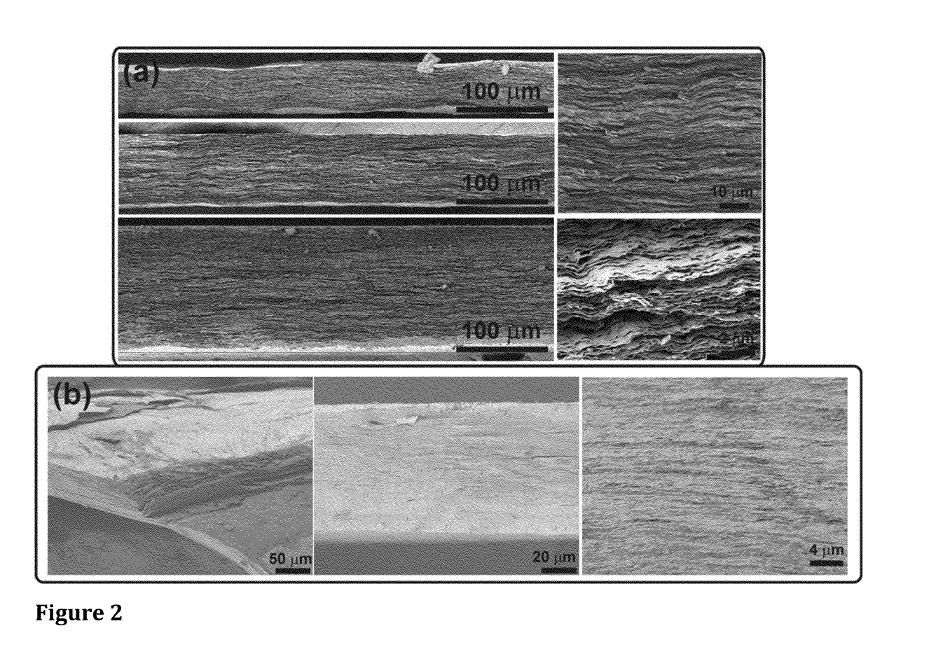

This leads to the generation of layered biomimetic structures as can be shown by scanning electron microscopy (SEM). FIGS. 2a and 2b demonstrate the layered orientation for composite materials obtained from method A and method B. FIG. 2a presents low and higher resolution SEM images for PDADMAC (poly(diallyl dimethyl ammonium chloride))/MTM composites and FIG. 2b displays images for composites generated by poly(isoprene)-block-poly(N-methyl 2-vinyl pyridinium) micelles (PI-P2VPq) adsorbed onto anionic microfibrillated cellulose.

The thickness of these materials can be tuned via the concentration or the amount used for the paper-making/filtration process as shown for the PDADMAC/MTM composites in FIG. 2a.

The optical properties of the resulting composite provide a high translucency due to the strong orientation of the materials inside the composite.

Due to the high content of reinforcing materials, these biomimetic composites show mechanical properties superior to standard composite materials. The Young's modulus typically reaches values between 5 and 45 GPa and the stiffness typically exhibits values between 100 and 300 MPa. The properties can be largely tuned by the addition of ionic or covalent crosslinkers. Introducing efficient crosslinkers multiplies stiffness and strength values of the materials. If high toughness is aimed, it is beneficial to utilize soft polymers with a lower glass transition temperature, such as polybutadiene, polyisoprene or strongly branched systems such as poly(ethylene imine) (PEI).

The mechanical properties for some of the PVA/MTM composites are shown in Table 1. Various crosslinking methods and preparation techniques are shown that clearly demonstrate the excellent stiffness and strength and the tunability of the materials.

Beyond mechanical properties, these materials exhibit excellent gas barrier and fire-retardancy properties. As one example, the oxygen transmission rate for the present nacre-mimetic paper was observed at as low as 0.325 cm³ mm/m²/day/atm even at high humidity (80%). This is among the best values for composites known.

In particular for inorganic fillers of components A and B, the materials exhibit an excellent fire retardant and shape-persistent behavior under exposed fire by a torch. Depending on the selection of component C, the composites display different flammability. Lowest flammability can be achieved when using polyphosphazene-based polymers or by selecting polymers rich in nitrogen, phosphor or halogens as the binder. These atoms can also be introduced by selecting appropriate counterions for polyelectrolyte-based components C. All materials with high content of inorganic filler are immediately self-extinguishing and behave like shape-persistent ceramics. Upon exposure to flames, the materials behave in an intumescent way and provide heat and fire shields.

### Method D

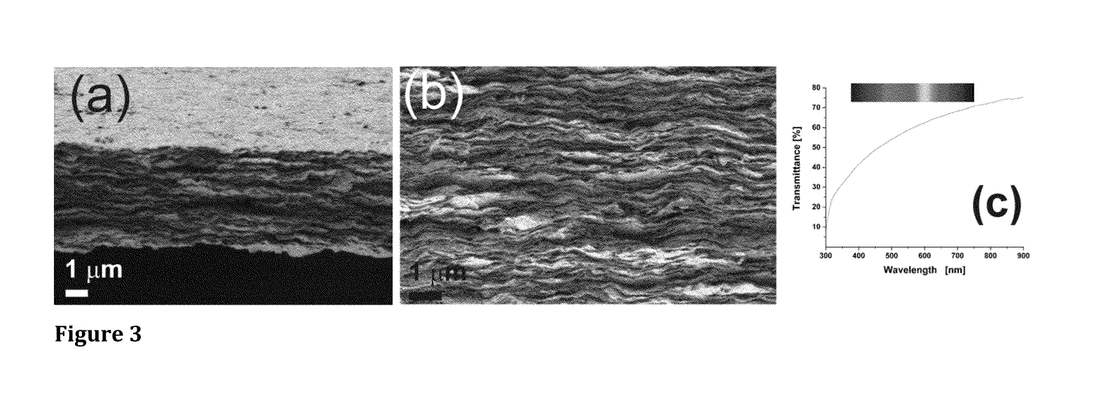

Self-assembled films are obtained by doctor-blading viscous slurries of the materials prepared via methods A and B onto substrates. The thickness of these coatings can be changed by changing the concentration or the conditions of the doctor-blading process. The process also imparts a layered structure inside the composite materials as for example shown for a PVA/MTM composite in FIG. 3a. The mechanical properties are similarly good fur such materials, but may vary to some extent compared to the paper-making/filtration process. The high optical translucency of such materials is shown on FIG. 3c for a doctor-bladed film.

### Method E

Self-assembled films are prepared via simple painting of viscous slurries using commercial paintbrushes. Similar considerations as in method D apply for the simple process of painting of such building blocks. Despite the rapid process, a comparably strong order can be induced inside the composite material as shown in FIG. 3b.

### Method F

Self-assembly of the hard/soft building blocks can be induced via pre-absorbing component C on component A or B to form a complex, followed by coagulation of the pre-formed complex of C and A and/or B.

### Example 1

Concerning method A, a 0.5 wt % dispersion of clay in MilliQ water is prepared by intense stirring for 1 week. This solution is allowed to settle down for 24 h and the supernatant fraction is then employed for the poly(vinyl alcohol) adsorption. To adsorb one monolayer of poly(vinyl alcohol) onto the clay platelets, the clay dispersion is slowly added to a stirred solution of polymer. The polymer solution typically has a concentration of 1-2.5 wt %. Subsequently, the excess polymer is removed by centrifugation and washing. Usually, two washing steps are applied. The polymer can also be removed by sedimentation and decantation. This material is termed PVA/MTM. SFM characterization is provided in FIG. 1, demonstrating a thin coating of PVA onto the MTM material.

### Example 2

Concerning method A, a 0.5 wt % dispersion of clay in MilliQ water is prepared by intense stirring for 1 week. This solution is allowed to settle down for 24 h and the supernatant fraction is then employed for the poly(diallyl dimethyl ammonium chloride) adsorption. To adsorb one monolayer of poly(diallyl dimethyl ammonium chloride) onto the clay platelets, the clay dispersion is slowly added to a stirred solution of polymer. The polymer solution typically has a concentration of 1-2.5 wt %. Subsequently, the excess polymer is removed by centrifugation and washing. Usually, two washing steps are applied. The polymer can also be removed by sedimentation and decantation. This material is termed PDADMAC/MTM

### Example 3

Concerning method A, a 0.5 wt % dispersion of clay in MilliQ water is prepared by intense stirring for 1 week. This solution is allowed to settle down for 24 h and the supernatant fraction is then employed for the chitosan adsorption. To adsorb one monolayer of chitosan onto the clay platelets, the clay dispersion is slowly added to a stirred solution of polymer. The polymer solution typically has a concentration of 2 wt % in aqueous acetic acid (adjusted to pH 4.7).

Subsequently, the excess polymer is removed by centrifugation and washing. Usually, two washing steps are applied. The polymer can also be removed by sedimentation and decantation. This material is termed chitosan/MTM.

### Example 4

Concerning Method B, a MFC dispersion of 0.7 wt % is mixed with a 2 mg/mL solution of (Polyisoprene-block-poly(N-methyl 2-vinyl pyridinium) block copolymer micelles, having molecular weights of 5.5 and 6.3 kDa, respectively, in a weight ratio of 2.5/1. Filtration/Paper-making according to method C leads to the generation of free-standing films, whose thickness can be tuned. FIG. 2 provides SEM characterization of a ca. 80 μm thick film with layered orientation of the NFC in plane with the filtration mat. This example has a Young's modulus of 6 GPa and sustains at least 90 MPa as ultimate stress at several percent of ultimate strain.

### Example 5

Concerning Method C, 100 mL of a 0.5 wt % solution of coated clay platelets as obtained via Method A and mentioned in Examples 1-3 are loaded onto a filtration unit and filtered through a 450 nm hydrophilic PTFE filter with 4.5 cm diameter. Afterwards, the disc-like specimens are removed and dried in an oven at 80° C. for 48 hours while applying a slight weight to maintain their circular shapes. The thickness of the specimens can be controlled by the volume or the concentration of the dispersion loaded onto the filter. SEM characterization, demonstrating the layered orientation, of a PDADMAC/MTM composite is provided in FIG. 2a. Depending of the volume of the dispersion used, different thicknesses from several micrometers to sub-millimeter can be achieved. These kind of PDADMAC/MTM composite films exhibit a Young's modulus of 12.9 GPa, a stress at break of 106 MPa and a strain at break of 2.1%. In case of PVA/MTM composites, a stiffness of 27 GPa can be achieved, while stress and strain at break reach 165 MPa and 1.7%, respectively. A complete set of data for the PVA/MTM composites is provided in Table 1.

### Example 6

Concerning Method D, a 15 wt % slurry of particles prepared following Method A and Examples 1-3 is coated onto a PET substrate via doctor-blading using clearances of 0.2 mm or 0.5 mm. In-situ crosslinked films can be obtained by premixing 7 mL of slurry with 1 mL of a 5 wt % glutaraldehyde solution for 5-10 min and subsequent doctor-blading. The films are dried in air. SEM characterization, demonstrating the layered orientation, of an uncrosslinked PVA/MTM composite obtained via doctor-blading is provided in FIG. 3b. A doctor-blade with a clearance of 0.2 mm results in the formation of ca 30 μm thick films. Uncrosslinked films obtained via doctor-blading lead to a stiffness of 21.3 GPa a stress at break of 105 MPa at an ultimate strain of 0.6%. In-situ crosslinking fortifies the stiffness to 34.2 GPa and the stress at break to 141 MPa. The strain at break remains similarly at 0.5%.

### Example 7

Concerning Method E, a 15 wt % slurry of particles prepared following Method A and Examples 1-3 is painted on a PET substrate with a commercial paintbrush and the films is dried in air. In-situ crosslinked films can be obtained by premixing 7 mL of slurry with 1 mL of a 5 wt % glutaraldehyde solution for 5-10 min and subsequent painting. The films are dried in air. SEM characterization, demonstrating the layered orientation, of an uncrosslinked PVA/MTM composite obtained via painting is provided in FIG. 3b. Film thicknesses can vary depending on paintbrush and application procedure. Here we show a film thickness below 10 μm.

### Example 8

Post-crosslinking of self-assembled films prepared from PVA/MTM dispersions is achieved via the following pathway. First, a PVA/MTM film is swollen in water for 12 h and subsequently immersed into a 5 wt % glutaraldehyde (50 mL) solution for 6 h. Afterwards, the film is washed in a water bath (500 mL) for 2 h and dried at 80° C.

### Example 9

For borate crosslinking, 90 mg of PVA/MTM composite film is immersed into a beaker containing 50 mL of water and adjusted to pH 11 with ammonia. After swelling for 12 h, 30 mg of boric acid is added and the film is allowed to react for one week. Afterwards, the film is washed in water for 2 h and then dried at 80° C.

A non-crosslinked film of PVA/MTM nacre-mimics exhibits a Young's modulus of 27 GPa and an ultimate stress at break of 165 MPA at 1.7% ultimate strain. Borate crosslinking of such films increases the stiffness to 45.6 GPa and the ultimate stress to 248 MPa. The ultimate strain is reduced to 0.9%.

### Example 10

For in-situ ionic crosslinking of the films during the processing, methods C-E, suitable multivalent salt solutions, can be added at various concentrations.

### Example 11

Defined counterion exchange and ionic crosslinking with a bivalent counterion is achieved for the PDADMAC/MTM composite via the following. The PDADMAC/MTM specimen is swollen in water overnight (40 mL) and then the water is exchanged to 200 mM solutions of CuSO4, (40 mL) and the system is allowed to rest for one week. Afterwards the film is transferred into a large amount of water (500 mL) and excess salt is allowed to diffuse out for 5 h. The water is exchanged after ca. 2.5 h. The sample is dried in an oven at 60° C. while applying a slight weight to maintain their circular shapes. Compared to the non-crosslinked PDADMAC/MTM example (example 5), this process increases the Young's modulus to 24.2 GPa, while the ultimate stress and strain reach values of 110 MPa and 0.7%, respectively.

### Example 12

Defined counterion exchange and ionic crosslinking with a trivalent counterion is achieved for the PDADMAC/MTM composite via the following. The PDADMAC/MTM specimen is swollen in water overnight (40 mL) and then the water is exchanged to 200 mM solutions of Na₃PO₄, (40 mL) and the system is allowed to rest for one week. Afterwards the film is transferred into a large amount of water (500 mL) and excess salt is allowed to diffuse out for 5 h. The water is exchanged after ca. 2.5 h. The sample is dried in an oven at 60° C. while applying a slight weight to maintain their circular shapes. Compared to the non-crosslinked PDADMAC/MTM example (example 5), this process increases the Young's modulus to 32.9 GPa, while the ultimate stress and strain reach values of 151 MPa and 0.8%, respectively.

### Example 13

Defined counterion exchange to thermally-crosslinkable counterion, e.g. sodium styrene sulfonate, is achieved for the PDADMAC/MTM composite via the following. The PDADMAC/MTM specimen is swollen in water overnight (40 mL) and then the water is changed to 200 mM solutions of e.g. sodium styrene sulfonate (40 mL) and the system is allowed to rest for one week. Afterwards the film is transferred into a large amount of water (500 mL) and excess salt is allowed to diffuse out for 5 h. The water is changed after ca. 2.5 h. The sample is dried in an oven at 60° C. while applying a slight weight to maintain their circular shapes. For polymerization, the specimen is brought to 160 C for 30 min. Compared to the non-crosslinked PDADMAC/MTM example (example 5). This process increases the Young's modulus to 29.3 GPa, while the ultimate stress and strain reach values of 119 MPa and 0.6%, respectively.

### Example 14

Concerning Method F, anionic NFC (nanofibrillar cellulose) can be complexed with cationic SBR latex in aqueous dispersion. The formed complex can be isolated from aqueous phase by coagulation and the formed material can be used as reinforcement in tires. This is a example how elastomer latexes can be used as the binder (component C) for nanoscale cellulosic material, and the assembly to form the composite material can be achieved by coagulation of the latex.

Some of the mechanical properties of composites obtained are collected in Table 1 below.

TABLE 1
Overview of material characteristics obtained for
the PVA/MTM system by tensile testing, as prepared
by papermaking and doctor-blading processes.

| | | Young's | Ultimate | Ultimate |
|---|---|---|---|---|
| Preparation | Additional | modulus | stress | strain |
| Method | treatment^{a} | (GPa) | (MPa) | (%) |
| Paper making | — (5) | 27.1 ± 2.8 | 165 ± 8.9 | 1.7 ± 0.4 |
| process | Hot-Pressed^{c} (7) | 26.6 ± 6.3 | 147 ± 8.5 | 1.6 ± 0.4 |
| PVA/MTM^{c} | GA X-link (7) | 26.7 ± 5.5 | 169 ± 18 | 1.3 ± 0.3 |
| | Borate X-link (7) | 45.6 ± 3.9 | 248 ± 19 | 0.9 ± 0.2 |
| Doctor-bladed | — (4) | 21.3 ± 3.9 | 105 ± 12 | 0.6 ± 0.1 |
| PVA/MTM^{b} | GA X-Link (5) | 34.2 ± 3.4 | 141 ± 16 | 0.5 ± 0.1 |

^{a}Number of samples used for the evaluation is given in brackets.
^{b}The material was dried at 80° C. for 48 h.
^{d}The material was dried at room temperature.
^{c}Hot-pressing was performed at 160° C./50 MPa for 20 min.

1-15. (canceled)

16. A method for preparing a composite structure, the method comprising forming self-assemblies of structural segments having three orthogonal directions and connecting to each other through binder material, said method comprising:
combining the structural segments, which in the three orthogonal directions have one or two dimensions larger than two or one remaining dimensions, respectively with the binder material to produce structural segments having the binder adhered thereto; and
combining said structural segments to a form a composite structure through self-assembly where the structural segments join to each other through said binder adhered to the structural segments and form an oriented reinforced composite structure.

17. The method according to claim 16, wherein the structural segments having the binder adhered thereto are self-assembled to a composite from a liquid medium where they are distributed.

18. The method according to claim 17, further comprising:
contacting the structural segments with the binder material in a liquid medium;
removing excess binder, where necessary;
dispersing the structural segments having the binder adhered thereto in a liquid medium; and
allowing the structural segments to form a composite trough self-assembly from the liquid medium.

19. The method according to claim 17, further comprising:
contacting the structural segments with the binder material in a liquid medium;
removing excess binder;
dispersing the structural segments having the binder adhered thereto in a liquid medium; and
allowing the structural segments to form a composite trough self-assembly from the liquid medium.

20. The method according to claim 16, wherein the structural segments are 2-dimensional or 1-dimensional particles of inorganic or organic origin, which in the three orthogonal directions have two dimensions or one dimension larger than the one or two remaining ones, respectively.

21. The method according to claim 20, wherein the structural segments are 2-dimensional particles of mineral or metallic origin.

22. The method according to claim 20, wherein the structural segments are 1-dimensional particles of inorganic or organic origin, such as carbon nanotubes or nanofibrillated cellulose.

23. The method according to claim 16, wherein the binder adhered to the structural segments is polymer.

24. The method according to claim 23, wherein the polymeric binder forms a monolayer on the structural segments.

25. The method according to claim 16, wherein the binder is adhered to the structural segments by chemisorption or physisorption.

26. The method according to claim 16, wherein after the self-assembly, the binder in the composite is cross-linked.

27. The method according to claim 16, wherein the composite is self-assembled from a liquid medium by doctor-blade coating on a substrate, painting on a substrate, filtering the liquid medium through a substrate, or spraying on a substrate.

28. The method according to claim 27, wherein the composite is allowed to remain as a coating on the substrate.

29. The method according to claim 28, wherein the composite is removed as a film from the substrate.

30. The method according to claim 16, wherein that the structural segments constitute over 70 wt-% of the total weight of the composite.

31. The method according to claim 1, further comprising:
utilizing the composite structure as
barrier material preventing a transmission of substances, either in a form of a separate film or in a form of a coating or layer in a laminate,
structural part,
thermal insulation,
fire protection,
refractory material,
electric insulation,
electric conductor, or
mechanical reinforcement.

32. A composite material, comprising:
nanoscale structural segments having three orthogonal directions, and binder material connecting the structural segments to ordered layers, said structural segments, which in the three orthogonal directions have two dimensions or one dimension larger than one or two remaining directions, respectively, being joined to each other in the composite material through a binder material which is pre-adhered to the structural segments and forming an oriented reinforced composite structure where the structural segments are self-assembled.

33. The composite material according to claim 32, wherein the binder material is polymer.

34. The composite material according to claim 33, wherein the polymer is crosslinked.

35. The composite material according to claim 32, wherein the structural segments constitute over 70 wt-% of the total weight of the composite.

36. The composite material according to claim 32, wherein the composite material forms
barrier material preventing the transmission of substances, either in the form of separate film or in the form of coating or layer in a laminate,
structural part,
thermal insulation,
fire protection,
refractory material,
electric insulation,
electric conductor, or
mechanical reinforcement.
